(19) United States
(12) Patent Application Publication
(10) Pub. No.: US 2015/0292548 A1
(43) Pub. Date: Oct. 15, 2015

(54) Crank arm

(71) Applicant: Jhong-Lin Wu, Kaohsiung (TW)

(72) Inventor: Jhong-Lin Wu, Kaohsiung (TW)

(21) Appl. No.: 14/748,256

(22) Filed: Jun. 24, 2015

(51) Int. Cl. F16C 3/28

(52) U.S. Cl. CPC F16C 3/28

(57) ABSTRACT

A crank arm includes an arm assembly including an auxiliary lever arm having a first gear at a first end, a second gear at a second end, and an intermediate gear meshed with the first gear and the second gear respectively; a main lever arm having a first end meshed with the second gear; and a detent member disposed on a surface of the first gear; and a crank pin secured to a center of the first gear through the detent member. The detent member is configured to lock the first gear so as to maintain the main lever arm at a predetermined angle with respect to the auxiliary lever arm. In another embodiment, the intermediate gear is replaced with a chain which puts on the first and second gears.

### BACKGROUND OF THE INVENTION

1. Field of the Invention

The invention relates to crank arms and more particularly to a crank arm having improved characteristics.

2. Description of Related Art

A typical crank arm includes an arm and a connecting part (e.g., gear). The arm can be rotated manually or by an engine to activate a mechanism.

However, the arm is a one piece member and is not adapted to adjust to work in a limited space (e.g., within an engine).

Thus, the need for improvement still exists.

### SUMMARY OF THE INVENTION

It is therefore one object of the invention to provide a crank arm comprising an arm assembly including an auxiliary lever arm having a first gear at a first end, a second gear at a second end, an intermediate gear meshed with the first gear and the second gear respectively, a first bore for accommodating the first gear, and a second bore for accommodating the second gear; a main lever arm having a first end meshed with the second gear; and a detent member disposed on a surface of the first gear; and a crank pin secured to a center of the first gear through the detent member; wherein the detent member is configured to lock the first gear so as to maintain the main lever arm at a predetermined angle with respect to the auxiliary lever arm.

The above and other objects, features and advantages of the invention will become apparent from the following detailed description taken with the accompanying drawings.

### BRIEF DESCRIPTION OF THE DRAWINGS

FIG. 1 is a perspective view of a crank arm according to a first preferred embodiment of the invention;

FIG. 2 is a bottom view of the crank arm;

FIG. 3 is a top view of the crank arm;

FIG. 4 is side elevation of the crank arm;

FIG. 5 is a top view of the auxiliary lever arm with cover removed;

FIG. 6A is a perspective view of a crank arm according to a second preferred embodiment of the invention with the housing removed;

FIG. 6B is a top view of the auxiliary lever arm shown in FIG. 6A;

FIG. 7 is a top view of the crank arm showing a rotation of the main lever arm;

FIG. 8 is another top view of the crank arm showing the rotation of the main lever arm;

FIG. 9 is a perspective view showing the crank arms mounted as a crankshaft of an internal combustion engine;

FIG. 10 is a side elevation of FIG. 9 showing a rotation of the crank arm;

FIG. 11 is a top view of the crank arm mounted on a bicycle;

FIG. 12 is a side elevation of FIG. 11; and

FIG. 13 is a top view of the crank arm showing the main lever arm rotated to a position overlapped the auxiliary lever arm.

### DETAILED DESCRIPTION OF THE INVENTION

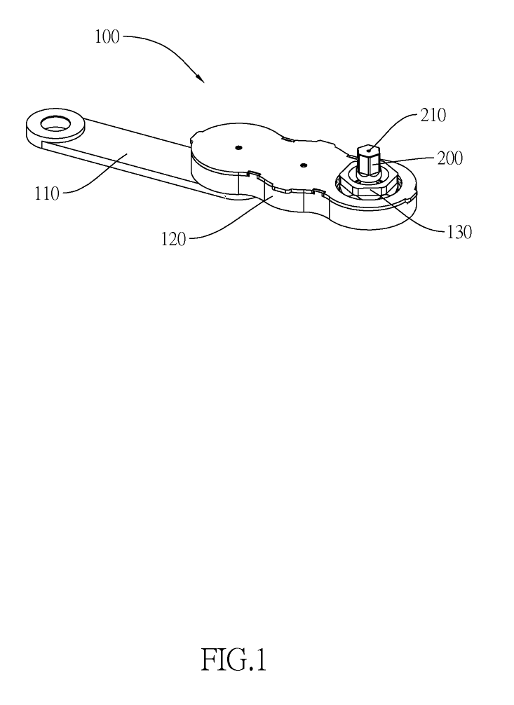

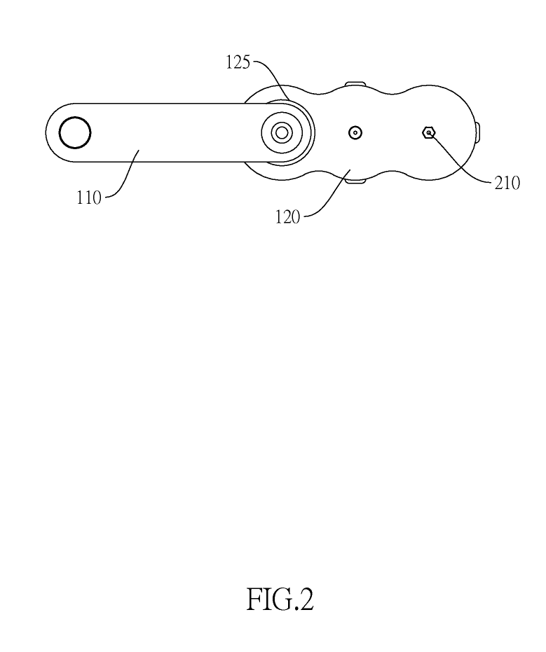

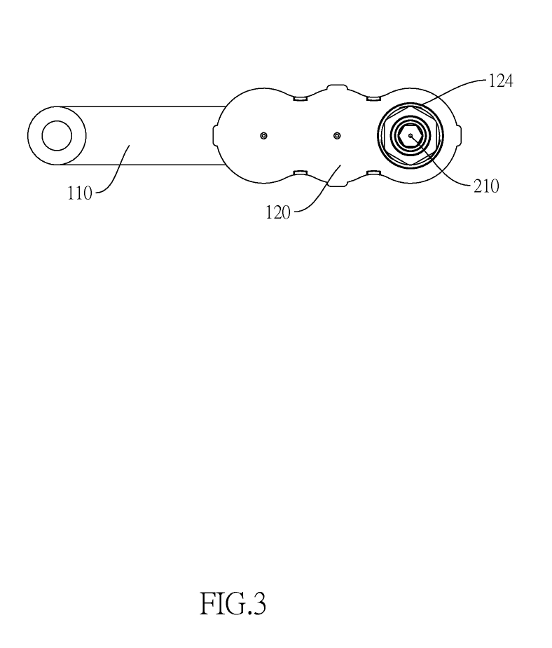

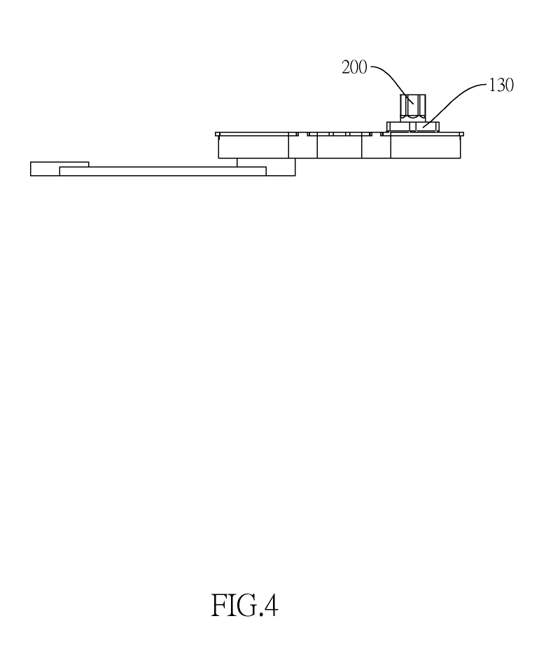

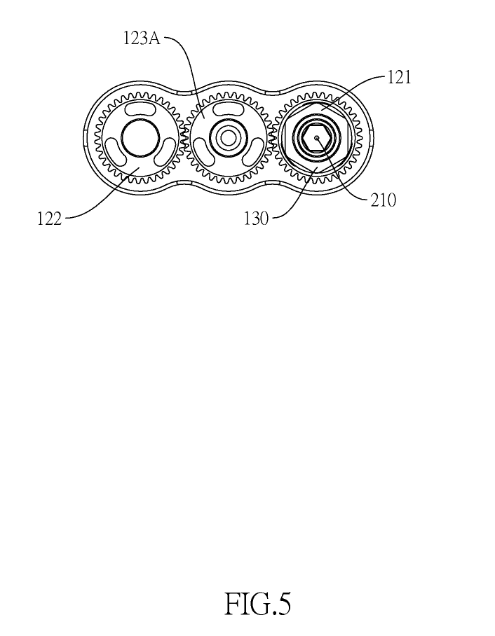

Referring to FIGS. 1 to 5, a crank arm in accordance with a first preferred embodiment of the invention comprises an arm assembly 100 and a crank pin 200 as discussed in detail below.

The arm assembly 100 includes a main lever arm 110 and an auxiliary lever arm 120. The auxiliary lever arm 120 includes a first gear 121 at a first end, a second gear 122 at a second end, and an intermediate gear 123A meshed with the first gear 121 and the second gear 122 respectively.

A first bore 124 is provided in the auxiliary lever arm 120 for accommodating the first gear 121 and a second bore 125 is provided in the auxiliary lever arm 120 for accommodating the second gear 122. A first end of the main lever arm 110 is meshed with the second gear 122 at the second bore 125. A detent member 130 is provided on one surface of the first gear 121 in the first bore 124. The crank pin 200 has a member 210 secured to a center of the first gear 121 through the detent member 130. The detent member 130 can lock the first gear 121 so as to lock the intermediate gear 123A which in turn locks the second gear 122. As a result, the main lever arm 110 can be maintained at its position, i.e., being at an angle with respect to the auxiliary lever arm 120.

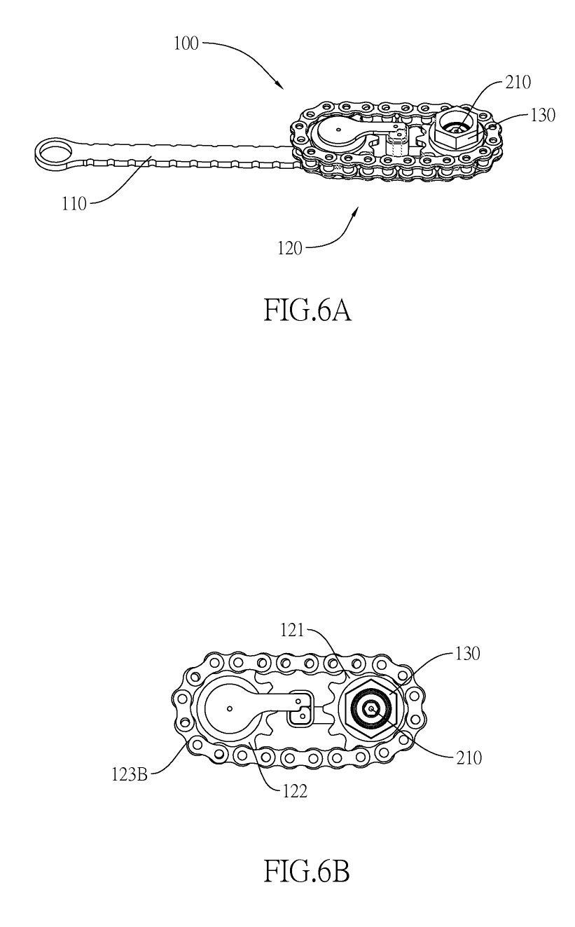

Referring to FIGS. 6A and 6B, a crank arm in accordance with a second preferred embodiment of the invention is shown. The characteristics of the second preferred embodiment are substantially the same as that of the first preferred embodiment except the following:

The auxiliary lever arm 120 includes a chain 123B put on the first gear 121 and the second gear 122. The detent member 130 can lock the first gear 121 so as to lock the chain 123B which in turn locks the second gear 122. As a result, the main lever arm 110 can be maintained at its position, i.e., being at an angle with respect to the auxiliary lever arm 120.

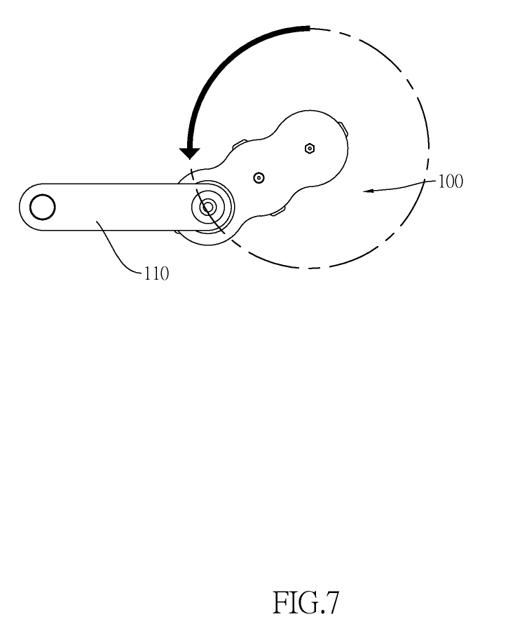

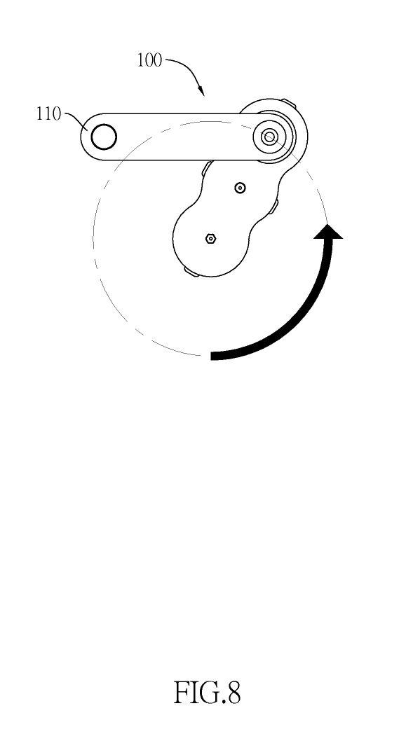

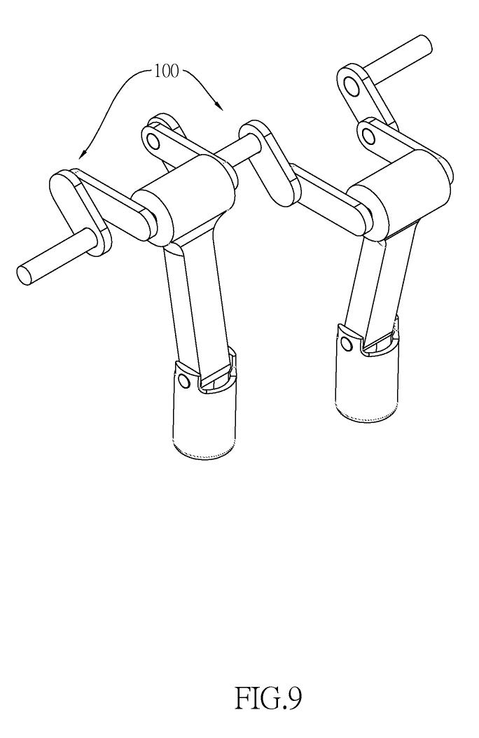

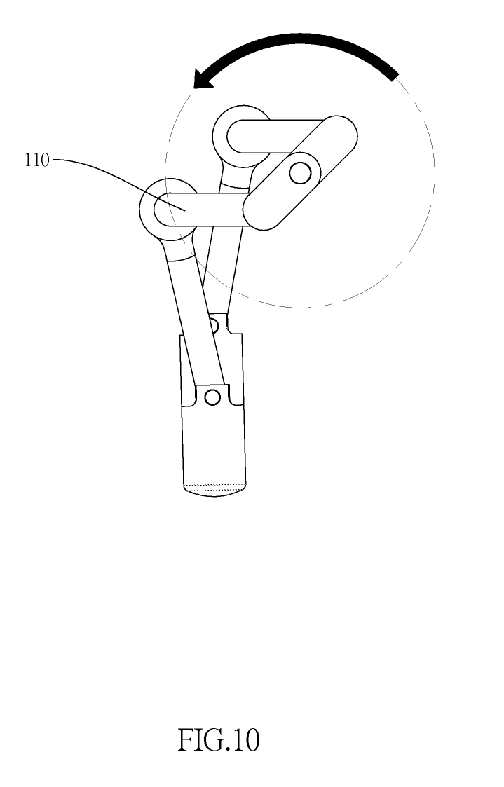

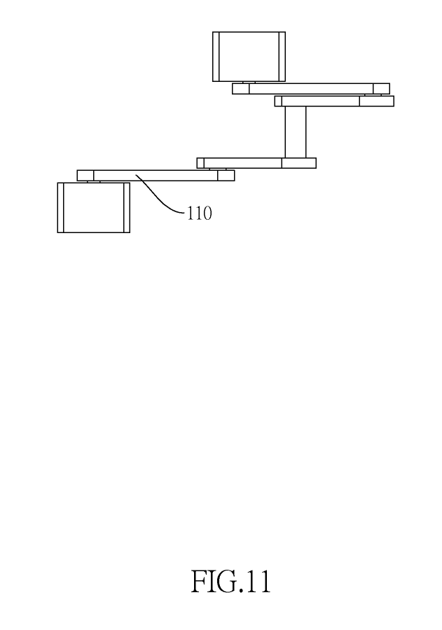

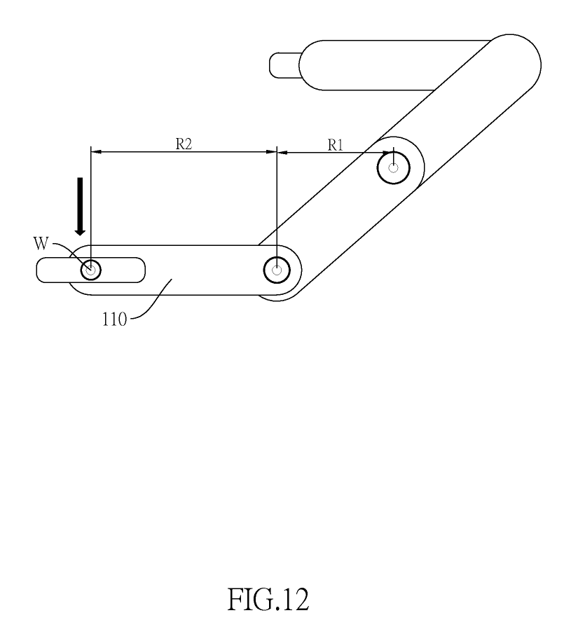

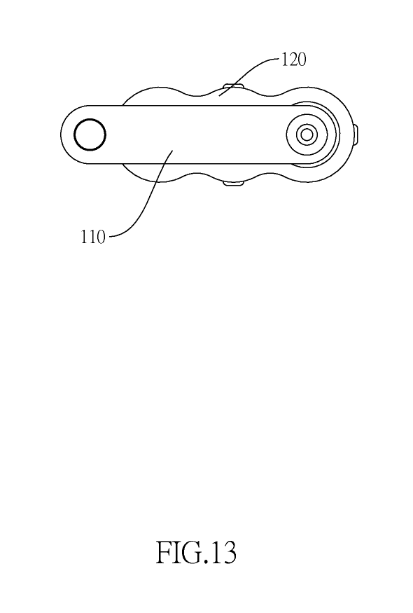

Referring to FIGS. 7 to 13 in conjunction with FIGS. 1 to 5, applications of the first preferred embodiment of the invention are described. The main lever arm 110 can rotate by pivoting about the first gear 121 (see FIGS. 7 and 8). The crank arm can be used as a crankshaft of an internal combustion engine (see FIGS. 9 and 10). Alternatively, the crank arm can be mounted on a bicycle (see FIG. 11). As shown in FIG. 12, torque is a cross product of (R1+R2, i.e., displacement vector) and W (i.e., force vector). Increase of the lever arm (i.e., R1+R2) results in an increase of torque. It is noted that length of the main lever arm 110 is greater than that of the auxiliary lever arm 120. Thus, a mechanism connected to a second end of the main lever arm 110 can maintain its normal operation when the main lever arm 110 is overlapped the auxiliary lever arm 120 (see FIG. 13).

While the invention has been described in terms of preferred embodiments, those skilled in the art will recognize that the invention can be practiced with modifications within the spirit and scope of the appended claims.

What is claimed is:

1. A crank arm comprising:
an arm assembly including an auxiliary lever arm having a first gear at a first end, a second gear at a second end, and a linking member meshed with the first gear and the second gear respectively; a main lever arm having a first end meshed with the second gear; and a detent member disposed on a surface of the first gear; and
a crank pin secured to a center of the first gear through the detent member;
wherein the linking member is a gear; and
wherein the detent member is configured to lock the first gear so as to maintain the main lever arm at a predetermined angle with respect to the auxiliary lever arm.

2. The crank arm of claim 1, wherein length of the main lever arm is greater than that of the auxiliary lever arm.

3. The crank arm of claim 1, wherein the linking member is a gear unit.

4. The crank arm of claim 1, wherein the linking member is a chain.

5. The crank arm of claim 1, wherein the first gear, the second gear, and the linking member are of the same size.

6. The crank arm of claim 3, wherein the first gear, the second gear, and the linking member are of the same size.

7. A crank arm comprising:
an arm assembly including an auxiliary lever arm having a first gear at a first end, a second gear at a second end, and a linking member put on both the first gear and the second gear; a main lever arm having a first end meshed with the second gear;
and a detent member disposed on a surface of the first gear; and
a crank pin secured to a center of the first gear through the detent member;
wherein the linking member is a chain; and
wherein the detent member is configured to lock the first gear so as to maintain the main lever arm at a predetermined angle with respect to the auxiliary lever arm.

8. The crank arm of claim 7, wherein length of the main lever arm is greater than that of the auxiliary lever arm.

9. The crank arm of claim 7, wherein the linking member is a gear unit.

10. The crank arm of claim 7, wherein the linking member is a chain.

11. The crank arm of claim 7, wherein the first gear, the second gear, and the linking member are of the same size.

12. The crank arm of claim 9, wherein the first gear, the second gear, and the linking member are of the same size.
